(19) United States
(12) Patent Application Publication
(10) Pub. No.: US 2009/0267887 A1
(43) Pub. Date: Oct. 29, 2009

(54) DATA DRIVING CIRCUIT, DISPLAY APPARATUS AND CONTROL METHOD OF DISPLAY APPARATUS

(76) Inventor: Wen-Jyh SAH, Tainan City (TW)

Correspondence Address: BIRCH STEWART KOLASCH & BIRCH, PO BOX 747, FALLS CHURCH, VA, 22040-0747, US

(21) Appl. No.: 12/427,973

(22) Filed: Apr. 22, 2009

(30) Foreign Application Priority Data
Apr. 23, 2008 (TW) 097114941

(51) Int. Cl. G09G 3/36

(52) U.S. Cl. 345/100

(57) ABSTRACT

A data driving circuit includes a shift register unit and a level shift unit. The level shift unit is electrically connected with the shift register unit and a plurality of data lines, respectively. The shift register unit receives a clock signal and at least one input image signal, and generates an output image signal. The level shift unit receives the output image signal, and generates a plurality of display signals for outputting to the data lines. A display apparatus and a control method thereof are also disclosed.

### CROSS REFERENCE TO RELATED APPLICATIONS

This Non-provisional application claims priority under 35 U.S.C. §119(a) on Patent Application No(s). 097114941 filed in Taiwan, Republic of China on Apr. 23, 2008, the entire contents of which are hereby incorporated by reference.

### BACKGROUND OF THE INVENTION

1. Field of Invention

The present invention relates to a data driving circuit, display apparatus, and control method of the display apparatus.

2. Related Art

The display apparatuses have been developed from the traditional cathode ray tube (CRT) display apparatuses to the liquid crystal display (LCD) apparatuses, organic light emitting diode (OLED) display apparatuses, and e-paper display apparatuses. The greatly reduced size and weight have made the present flat display apparatuses more advantageous and widely used on communication, information, and consumer electronic products.

FIG. 1 is a schematic view of a conventional display apparatus 1, which is an LCD display apparatus as an example. With reference to FIG. 1, the conventional display 1 includes a LCD panel 11 and a data driving circuit 12. The data driving circuit 12 is electrically connected to the LCD panel 11 through a plurality of data lines D01-D0m.

The data driving circuit 12 includes a shift register unit 122, a first stage latch unit 123, a second stage latch unit 124 and a level shift unit 125. The shift register unit 122 is electrically connected to the first stage latch unit 123, and the second stage latch unit 124 electrically connects the first stage latch unit 123 with the level shift unit 125.

FIG. 2 is a clock control diagram of the data driving circuit 12 of the conventional display apparatus 1. With reference to FIG. 2, the shift register unit 122 generates the shift register signals SR1-SRN according to a start pulse signal S01 and a clock signal CK, and transmits the shift register signals SR1-SRN to the first stage latch unit 123.

The first stage latch unit 123 receives the shift register signals SR1-SRN and receives an image signal S02 according to the shift register signals SR1-SRN. The image signal S02 includes a plurality of image data and is stored in the first stage latch unit 123. The image signal S02 is captured for outputting to the second stage latch unit 124 according to a latch enabling signal S03. The level shift unit 125 converts the image signal S02, which is stored in the second stage latch unit 124, into a display signal, and transmits the image signal S02 to the LCD panel 11 for showing a display image through the corresponding data lines D01-D0m.

However, since the current display apparatus tend to be lighter, thinner, shorter, and smaller in size, the production cost can be lowered with a decreased number of the components while keeping the current display apparatus structure and functions. Therefore, it is an important subject to provide the data driving circuit, display apparatus, and control method of the display apparatus with fewer components.

### SUMMARY OF THE INVENTION

In view of the foregoing, the present invention is to provide a data driving circuit, display apparatus, and a control method of the display apparatus with fewer components.

The data driving circuit of the present invention is to convert the input image signal into another format. The input image signal includes the information or graphics displayed on the display apparatus and the converted signal may directly drive the pixel circuit of the display apparatus. In the present invention, the data driving circuit may be a source driving circuit or a column driving circuit.

To achieve the above, the present invention provides a data driving circuit including a shift register unit and a level shift unit. The shift register unit receives a clock signal and at least one input image signals, and generates an output image signal. The level shift unit is electrically connected to the shift register unit and a plurality of data lines. The level shift unit receives the output image signal and generates a plurality of display signals to the data lines according to the output image signal.

To achieve the above, the present invention is to provide a display apparatus having a display panel and a data driving circuit. The pixel arrangement on the display panel may be a one-dimensional matrix or a two-dimensional matrix. The data driving circuit is electrically connected to the display panel through a plurality of data lines and has a shift register unit and a level shift unit. The shift register unit receives a clock signal and at least one input image signal, and generates an output image signal. The level shift unit is electrically connected to the shift register unit and a plurality of data lines. The level shift unit receives the output image signal, and generates a plurality of display signals for outputting to the display panel according to the output image signal.

To achieve the above, the present invention is to provide a control method of a display apparatus that has a display panel and a data driving circuit. The data driving circuit includes a shift register unit and a level shift unit. The control method of the display apparatus includes inputting a clock signal and at least one input image signal to the shift register unit; generating an output image signal to the level shift unit by the shift register unit according to the input image signal; and generating a plurality of display signals for outputting to the display panel by the level shift unit according to the output image signal.

To achieve the above, the present invention is to provide a data driving circuit including a shift register unit, a level shift unit, and a sample-hold unit. The shift register unit receives a clock signal and at least one input image signal, and generates an output image signal. The level shift unit is electrically connected to the shift register unit, receives the output image signal, and generates a control signal according to the output image signal. The sample-hold unit is electrically connected to the level shift unit and a plurality of data lines, receives the control signal and an input level signal, and generates a plurality of display signals for outputting to the data lines according to the control signal and the input level signal.

To achieve the above, the present invention is to provide a display apparatus including a display panel and a data driving circuit. The pixel arrangement on the display panel may be a one-dimensional matrix or a two-dimensional matrix. The data driving circuit is electrically connected to the display panel through the data lines and has a shift register unit, a level shift unit, and a sample-hold unit. The shift register receives a clock signal and at least one input image signals, and generates an output image signal. The level shift unit is electrically connected to the shift register unit, receives the output image signal, and generates a control signal according to the output image signal. The sample-hold unit is electrically connected to the level shift unit and a plurality of data lines, receives the control signal and an input level signal, and generates a plurality of display signals for outputting to the display panel according to the control signal and the input level signal.

To achieve the above, the present invention is to provide a control method of a display apparatus, which has a display panel and a data driving circuit. The data driving circuit has a shift register unit, a level shift unit, and a sample-hold unit. The control method of the display apparatus includes inputting a clock signal and at least one input image signal to the shift register unit; generating an output image signal for outputting to the level shift unit by the shift register unit according to the input image signal; generating a control signal for outputting to the sample-hold unit by the level shift unit according to the output image signal; and receiving an input level signal and the control signal and generating a plurality of display signals for outputting to the display panel by the sample-hold unit according to the input level signal and the control signal.

As described above, according to the data driving circuit, display apparatus, and control method of the display apparatus of the present invention, the data driving circuit includes the shift register unit and level shift unit, and outputs the plurality of display signals to the display panel. Compared to the prior art, the data driving circuit and display apparatus of the present invention do not require the first stage latch unit and the second stage latch unit to process the input image signal. Thus, the data driving circuit, display apparatus, and control method of the display apparatus may save spaces in a product so to reduce the production cost.

### BRIEF DESCRIPTION OF TH E DRAWINGS

The invention will become more fully understood from the detailed description and accompanying drawings, which are given for illustration only, and thus are not limitative of the present invention, and wherein:

FIG. 1 is a schematic view of a data driving circuit of a conventional display apparatus;

FIG. 2 is a clock control diagram of the data driving circuit of the conventional display apparatus;

FIG. 3 is a schematic view of a data driving circuit according to a first embodiment of the present invention;

FIG. 4 is a clock control diagram of the data driving circuit according to the first embodiment of the present invention;

FIG. 5 is a schematic view of a display apparatus according to the first embodiment of the present invention;

FIG. 6 is a flow chart of a control method according to the first embodiment of the present invention;

FIG. 7 is a schematic view of a data driving circuit according to a second embodiment of the present invention;

FIG. 8 is a clock control diagram of the data driving circuit according to the second embodiment of the present invention;

FIG. 9 is a schematic view of the display apparatus according to the second embodiment of the present invention; and

FIG. 10 is a flow chart of a control method according to the second embodiment of the present invention.

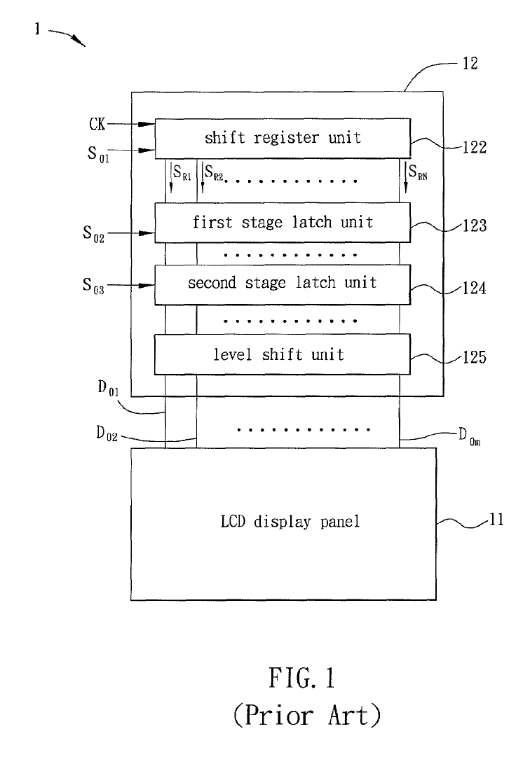

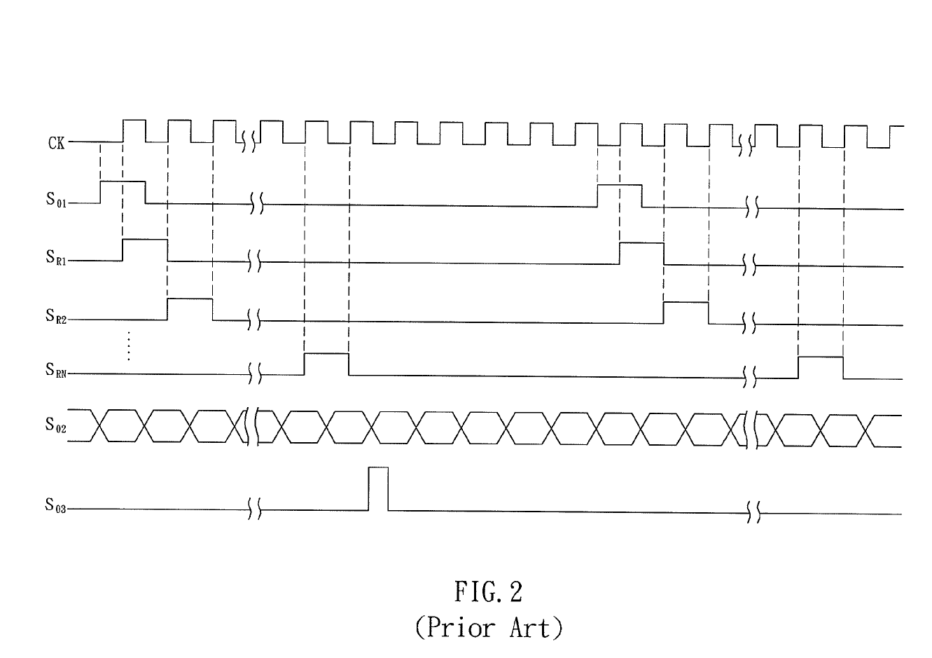

### DETAILED DESCRIPTION OF THE INVENTION

The present invention will be apparent from the following detailed description, which proceeds with reference to the accompanying drawings, wherein the same references relate to the same elements.

### First Embodiment

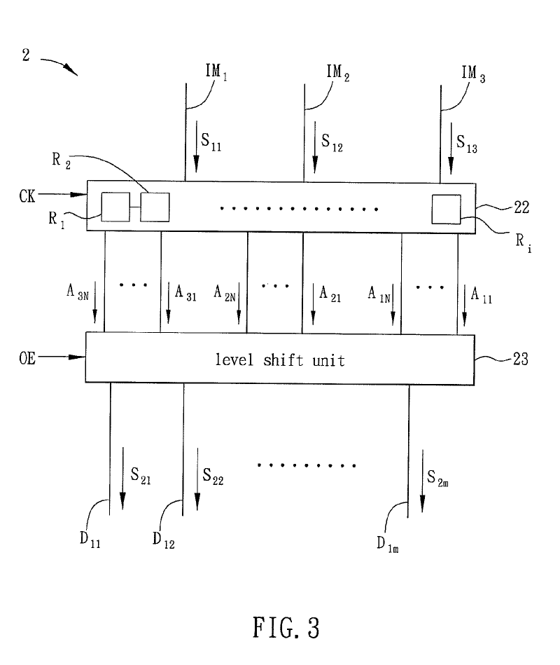

FIG. 3 is a schematic view of a data driving circuit according to a first embodiment of the present invention. With reference to FIG. 3, the data driving circuit 2 includes a shift register unit 22 and a level shift unit 23. The level shift unit 23 electrically connects the shift register unit 22 with a plurality of data lines D11-D1m, in which m is an integer greater than 1.

It is noted that the electrical connection herein may be a direct electrical connection or an indirect electrical connect, which is to electrically connect two elements by another element (e.g. a buffer element).

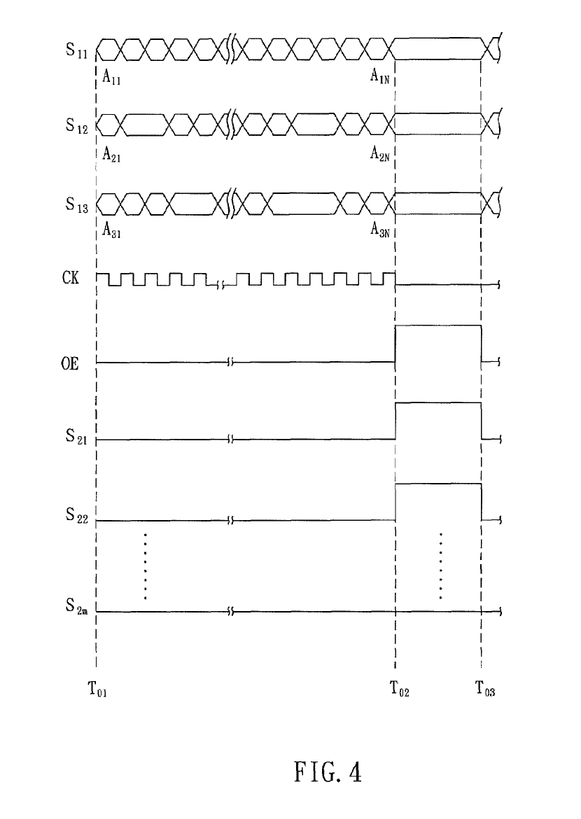

The shift register unit 22 includes a plurality of registers R1-Ri and receives at least one input image signal. In the embodiment, the shift register unit 22 is electrically connected to three input image signal lines IM1-IM3 for receiving three input image signals S11-S13 that form a display image. The input image signals S11-S13 may be shown in FIG. 4, where the input image signal S11 includes a plurality of image data A11-A1N, the input image signal S12 includes a plurality of image data A21-A2N, and the input image signal S13 includes a plurality of image data A31-A3N.

Meanwhile, the shift register unit 22 also receives a clock signal CK. In the embodiment, the shift register unit 22 orderly receives input image signals S11-S13 during time T01-T02 according to the clock signal CK.

The way that the shift register unit 22 receives the input image signals S11-S13 is described in detail as follows. The shift register unit 22 starts receiving the input image signals S11-S13 responding to the clock signal CK at time T01. Firstly, after the shift register unit 22 receives the image data A11, A21, and A31, the image data A11 is temporarily stored in the register R1, the image data A21 is temporarily stored in the register R2, and the image data A31 is temporarily stored in the register R3. With the clock signal CK, the image data A11-A3N are orderly stored in the shift registers R1-Ri.

Due to the output enabling signal OE turns off the level shift unit 23 during time T01-T02, the level shift unit 23 will not transform the data image A11-A3N of the registers R1-Ri to the voltage value required by the corresponding data lines D11-D1m, such that the data lines D11-D1m are at a low-voltage or in a floating state.

FIG. 4 is a clock control diagram of the data driving circuit according to the first embodiment of the present invention. As shown in FIG. 4, during time T02-T03 the clock signal CK is at a fixed level such as a low voltage level, or is at a high voltage level or in a floating state in different embodiments, such that the shift register unit 22 stops the movement in the registers R1-Ri. At this time, the shift register unit 22 generates the output image signal to the level shift unit 23 and the output image signal includes image data A11-A3N. Voltage levels of the image data A11-A3N can be separately adjusted by the level shift unit 23.

Meanwhile, compared to the clock signal CK, the output enabling signal OE is at the high voltage level. Thus, the level shift unit 23 receives the output enabling signal OE and converts the output image signal into the display signals S21-S2m according to the output enabling signal OE. After that, the display signals S21-S2m are outputted to the corresponding data lines D11-D1m. The levels of the display signals S21-S2m vary depending on the desired images and not limited to those shown in the figure.

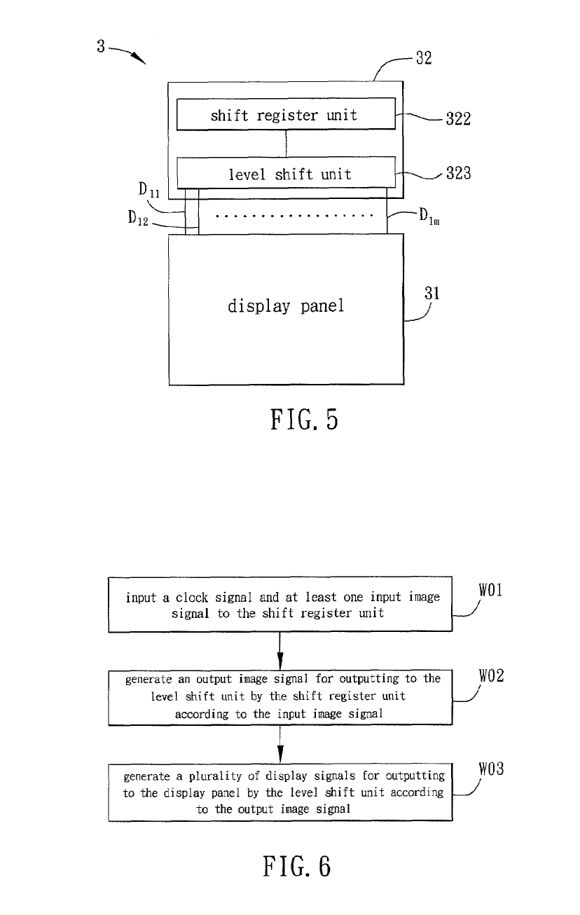

FIG. 5 is a schematic view of a display apparatus according to the first embodiment of the present invention. With reference to FIG. 5, the display apparatus 3 according to the first embodiment of the present invention includes a display panel 31 and a data driving circuit 32, which is electrically connected to the display panel 31 through a plurality of data lines D11-D1m. In the first embodiment, the display panel 31 may be a non-volatile display panel, which is the display panel 31 that has at least two steady states may maintain in the steady state for at least several tens milliseconds after the power source is removed. In addition, the optical modulating material of the display panel 31 may include an electrophoretic solution, an electrowetting material, a cholesterol liquid crystal, or a nematic liquid crystal. The display panel 31 further includes at least one pixel (not shown) and the pixel arrangement may be a one-dimensional matrix or a two-dimensional matrix.

The shift register unit 322 and the level shift unit 323 of the data driving circuit 32 have the same functions, circuits, and movements as those of the shift register unit 22 and the level shift unit 23 of the data driving circuit 2 in FIG. 3. Therefore, a detailed description thereof will be omitted herein.

At least a part of the shift register unit 322 and the level shift unit 323 are disposed on an integrated circuit (IC) chip by the single crystal semiconductor manufacturing process or on the same substrate by the poly crystal manufacturing process or amorphous manufacturing process, where the amorphous manufacturing process may be an amorphous silicon TFT manufacturing process or an organic TFT manufacturing process.

FIG. 6 is a flow chart of a control method according to the first embodiment of the present invention. The control method according to the first embodiment of the present invention is applied to the display apparatus 3 in FIG. 5 and includes steps W01 to W03.

Step W01 is to input a clock signal and at least one input image signal to the shift register unit. Step W02 is to generate an output image signal for outputting to the level shirt unit by the shift register unit according to the input image signal. Step W03 is to generate a plurality of display signals for outputting to the display panel by the level shift unit according to the output image signal.

The detailed description of the control method is shown in FIGS. 3-5; therefore the description thereof will be omitted herein.

### Second Embodiment

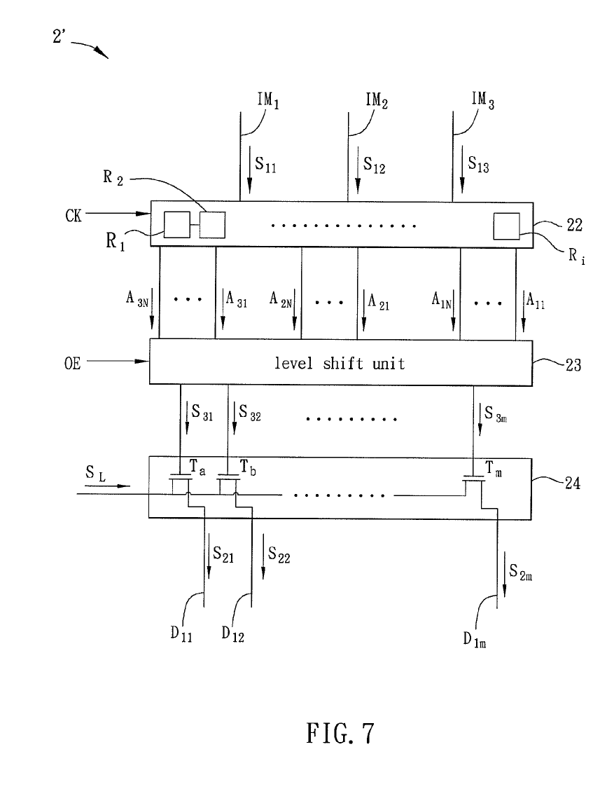

The data driving circuit 2′ of the present invention further includes a sample-hold unit 24 other than the shift register unit 22 and level shift unit 23 as described in the first embodiment. At least a part of the sample-hold unit 24 is produced by the single crystal manufacturing process, poly crystal manufacturing process, or amorphous manufacturing process. With reference to FIG. 7, the sample-hold unit 24 includes a plurality of switches Ta-Tm and receives an input level signal SL. Each of the switches Ta-Tm is electrically connected to the level shift unit 23 and the corresponding data lines D11-D1m. In the second embodiment, the switches Ta-Tm may be transistors, respectively.

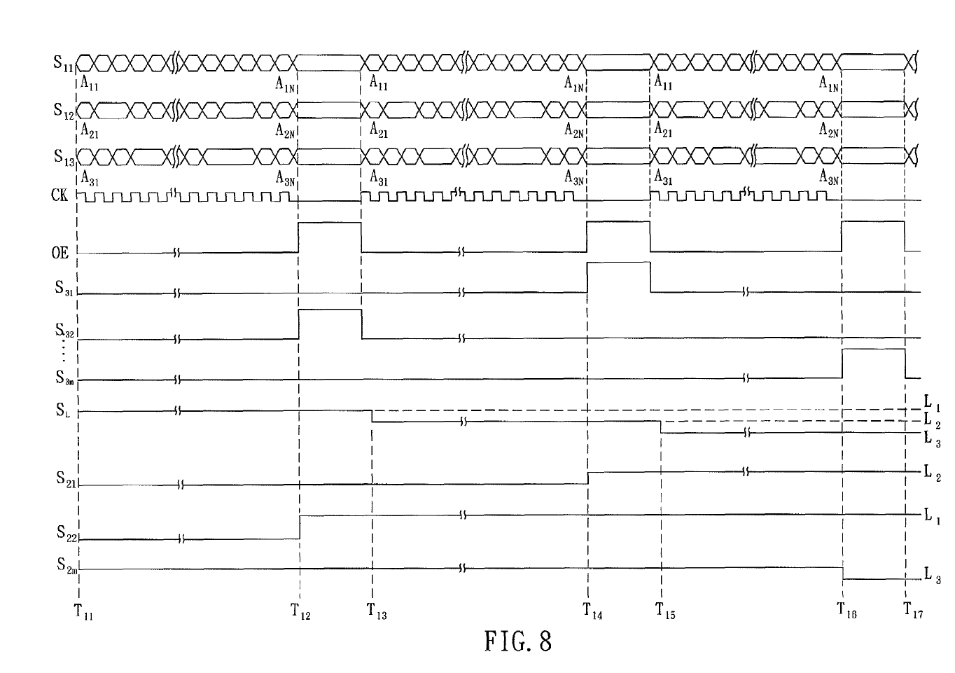

FIG. 8 is a clock control diagram of the data driving circuit according to the second embodiment of the present invention. With reference to FIG. 8, during time T11-T12, the shift register unit 22 orderly receives input image signals S11-S13 according to the clock signal CK, the image signals S11-S13 includes the image data A11-A3N. At the same time, the input enabling signal OE will turn off the level shift unit 23.

The clock signal CK is at a fixed level during time T12-T13, such that the shift register unit 22 stops the shifting movement in the registers R1-Ri. Meanwhile, the level shift unit 23 receives the image data A11-A3N and generates the control signal S31-S3m for outputting to the sample-hold unit 24 according to the output enabling signal OE.

The sample-hold unit 24 receives the control signals S31 -S3m and the input level signal SL and generates the display signals S21-S2m for outputting to the data lines D11-D1m according to the control signals S31-S3m and the input level signal SL. A detail description of how the sample-hold unit 24 will be described as follows.

The sample-hold unit 24 receives the input level signal SL and includes a first level L1, a second level L2, and a third level L3. In the embodiment, the input level signal SL has, for example but not limited to, the first level L1 during time T11-T13, the second level L2 during time T13-T15, the third level L3 during time T15-T17. The third level L3 is between the first level L1 and the second level L2.

FIG. 8 is a clock control diagram of the data driving circuit according to the second embodiment of the present invention. As shown in FIG. 8, when the sample-hold unit 24 outputs the display signal S22 that has the first level L1, during time T12-T13 the clock signal CK is at a fixed level such as a low voltage level, and the output enabling signal OE and the control signal S32 output a high voltage level to turn on the switch Tb, so that the display signal S22 outputs the first level L1.

When the sample-hold unit 24 outputs the display signal S21 that has the second level L2, during time T14-T15 the clock signal CK is at a fixed level such as a low voltage level, and the output enabling signal OE and the control signal S31 output a high voltage level to turn on the switch Ta, so that the display signal S21 outputs the second level L2.

When the sample-hold unit 24 is outputs the display signal S2m that has the third level L3, during time T16-T17 the clock signal CK is at a fixed level such as a low voltage level, and the output enabling signal OE and the control signal S3m output a high voltage level to turn on the switch Tm, so that the display signal S2m outputs the third level L3.

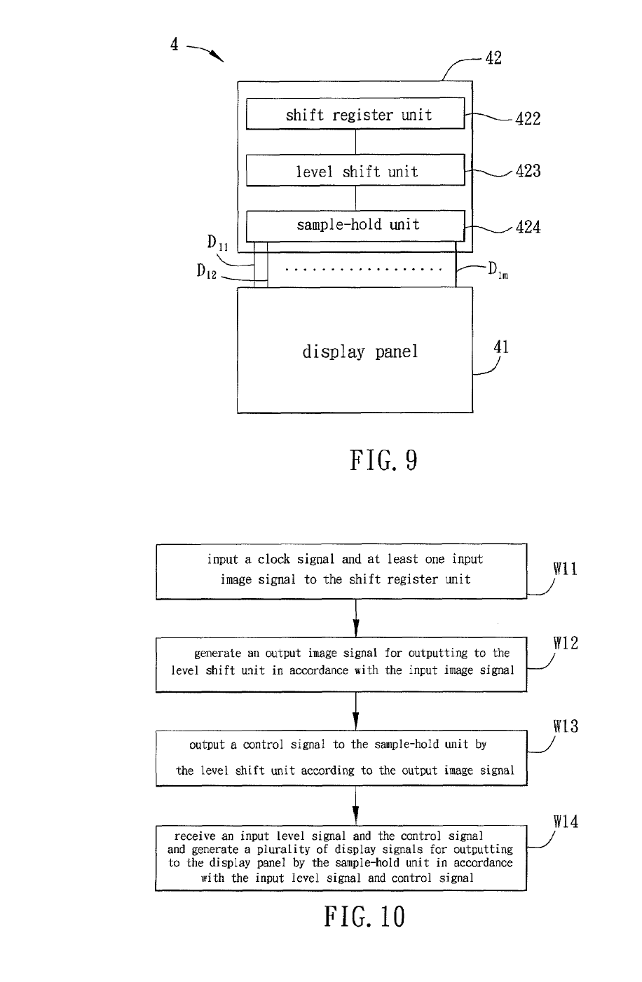

FIG. 9 is a schematic view of the display apparatus according to the second embodiment of the present invention. With reference to FIG. 9, the display apparatus 4 includes a display panel 41 and a data driving circuit 42 that is electrically connected to the display panel 41 through the data lines D11-D1m. The shift register unit 422, level shift unit 423, and sample-hold unit 424 of the data driving circuit 42 have the same functions, circuits and movements as those of the shift register unit 22, level shift unit 23, and sample-hold unit 24 of the data driving circuit 2′ as shown in FIG. 7. Therefore a detailed description thereof will be omitted herein.

FIG. 10 is a flow chart of a control method according to the second embodiment of the present invention. With reference to FIG. 10, the control method of the second embodiment is applied to the display apparatus 4 in FIG. 9 and includes steps W11 to W14.

Step W11 is to input a clock signal and at least one input image signal to the shift register unit. Step W12 is to generate an output image signal for outputting to the level shift unit in accordance with the input image signal. Step W13 is to output a control signal to the sample-hold unit by the level shift unit according to the output image signal. Step W14 is to receive an input level signal and the control signal, and generate a plurality of display signals for outputting to the display panel by the sample-hold unit in accordance with the input level signal and control signal.

The control method has been described in the above-mentioned embodiment, thus a detailed description thereof is omitted.

To sum up, according to the data driving circuit, display apparatus, and control method of the display apparatus of the present invention, the data driving circuit includes shift register unit and level shift unit and outputs the display signals to the display panel. Compared to the prior art, the data driving circuit and the display apparatus of the present invention do not need a latch unit to process the input image signals so as to save spaces in a product and reduce the production cost.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A data driving circuit, comprising:
a shift register unit receiving a clock signal and at least one input image signal, and generating an output image signal; and
a level shift unit electrically connected to the shift register unit and a plurality of data lines for receiving the output image signal and generating a plurality of display signals for outputting to the data lines.

2. The data driving circuit according to claim 1, wherein the output image signal comprises a plurality of image data and the shift register unit receives the image data orderly.

3. The data driving circuit according to claim 1, wherein the level shift unit adjusts a voltage level of the output image signal.

4. The data driving circuit according to claim 1, wherein the level shift unit further receives an output enabling signal and outputs the display signals to the data lines in accordance with the output enabling signal.

5. A data driving circuit, comprising:
a shift register unit receiving a clock signal and at least one input image signal and generating an output image signal;
a level shift unit electrically connected to the shift register unit for receiving the output image signal and generating a control signal in accordance with the output image signal; and
a sample-hold unit electrically connected to the level shift unit and a plurality of data lines for receiving the control signal and an input level signal and generating a plurality of display signals for outputting to the data lines in accordance with the control signal and the input level signal.

6. The data driving circuit according to claim 5, wherein the input image signal comprises a plurality of image data and the shift register unit receives the image data orderly.

7. The data driving circuit according to claim 5, wherein the level shift unit adjusts a voltage level of the output image signal.

8. The data driving circuit according to claim 5, wherein the level shift unit further receives an output enabling signal and outputs the control signal to the sample-hold unit in accordance with the output enabling signal.

9. A display apparatus, comprising:
a display panel; and
a data driving circuit electrically connected to the display panel through a plurality of data lines, the data driving circuit comprising:
a shift register unit receiving a clock signal and at least one input image signal and generating an output image signal,
a level shift unit electrically connected to the shift register unit for receiving the output image signal and generating a control signal in accordance with the output image signal, and
a sample-hold unit electrically connected to the level shift unit and a plurality of data lines for receiving the control signal and an input level signal, and generating a plurality of display signals for outputting to the display panel in accordance with the control signal and the input level signal.

10. The display apparatus according to claim 9, wherein the input image signal comprises a plurality of image data and the shift register unit receives the image data orderly.

11. The display apparatus according to claim 9, wherein the level shift unit adjusts a voltage level of the output image signal.

12. The display apparatus according to claim 9, wherein the level shift unit further receives an output enabling signal and generates the control signal in accordance with the output enabling signal.

13. The display apparatus according to claim 9, wherein the display panel is a non-volatile display panel.

14. A display apparatus, comprising:
a display panel; and
a data driving circuit electrically connected to the display panel through a plurality of data lines, the data driving circuit comprising:
a shift register unit receiving a clock signal and at least one input image signal and generating an output image signal, and
a level shift unit electrically connected to the shift register unit and the display panel for receiving the output image signal and generating a plurality of display signals for outputting to the display panel.

15. The display apparatus according to claim 14, wherein the input image signal comprises a plurality of image data and the shift register unit receives the image data orderly.

16. The display apparatus according to claim 14, wherein the level shift unit adjusts a voltage level of the output image signal.

17. The display apparatus according to claim 14, wherein the level shift unit further receives an output enabling signal and outputs the display signals to the display panel in accordance with the output enabling signal.

18. A control method of a display apparatus having a display panel and a data driving circuit, wherein the data driving circuit has a shift register unit and a level shift unit, the control method comprising the steps of:
inputting a clock signal and at least one input image signal to the shift register unit;
generating an output image signal for outputting to the level shift unit by the shift register unit in accordance with the input image signal; and
generating a plurality of display signals for outputting to the display panel by the level shift unit in accordance with the output image signal.

19. The control method according to claim 18, wherein the input image signal comprises a plurality of image data orderly inputted to the shift register unit.

20. The control method according to claim 18, further comprising a voltage level of the input image signal adjusted by the level shift unit.

21. The control method according to claim 18, further comprising:
inputting an input enabling signal to the level shift unit; and
outputting the display signals to the display panel by the level shift unit in accordance with the output enabling signal.

22. A control method of a display apparatus having a display panel and a data driving circuit, wherein the data driving circuit has a shift register unit, a level shift unit, and a sample-hold unit, the control method comprising the steps of:
inputting a clock signal and at least one input image signals to the shift register unit;
generating an output image signal to the level shift unit by the shift register unit in accordance with the input image signal;
outputting a control signal to the sample-hold unit by the level shift unit in accordance with the output image signal; and
receiving an input level signal and the control signal, and generating a plurality of display signals for outputting to the display panel by the sample-hold unit in accordance with the input level signal and the control signal.

23. The control method according to claim 22, wherein the input image signal comprises a plurality of image data orderly inputted to the shift register unit.

24. The control method according to claim 22, further comprising a voltage level of the input image signal adjusted by the level shift unit.

25. The control method according to claim 22, further comprising:
inputting an input enabling signal to the level shift unit; and
outputting the control signal to the sample-hold unit by the level shift unit in accordance with the output enabling signal.
